(19) United States
(12) Patent Application Publication
(10) Pub. No.: US 2008/0236589 A1
(43) Pub. Date: Oct. 2, 2008

(54) Portable respirator with oxygen supply

(76) Inventor: Lela V. Bronson, Washington, DC (US)

Correspondence Address: LITMAN LAW OFFICES, LTD., P.O. BOX 15035, CRYSTAL CITY STATION, ARLINGTON, VA, 22215-0035, US

(21) Appl. No.: 11/902,589

(22) Filed: Sep. 24, 2007

Related U.S. Application Data
(60) Provisional application No. 60/906,233, filed on Mar. 12, 2007.

(51) Int. Cl. A62B 18/08

(52) U.S. Cl. 128/206.24

(57) ABSTRACT

The portable emergency respirator comprises a case having a compartment therein. An oxygen supply is disposed inside of the heat resistant container body. An elongated tube connected to an airtight aperture of container body extends from the container body to deliver oxygen to an oxygen respirator mask. The oxygen respirator mask has a plurality of head straps and adjustment buckles. The respirator mask is preferably rubber-sealed for efficient delivery of oxygen to the wearer and to prevent toxic environmental air from reaching the wearer's lungs.

### CROSS-REFERENCE TO RELATED APPLICATION

This application claims the benefit of U.S. Provisional Patent Application Ser. No. 60/906,233, filed Mar. 12, 2007.

### BACKGROUND OF THE INVENTION

1. Field of the Invention

The present invention generally relates to respiratory devices, and more particularly to a portable emergency respirator, which provides a pocket-sized case to be held by or attached to a person to supply oxygen to the person when needed.

2. Description of the Related Art

In various emergency situations, such as fires, a person may not be able to make an immediate escape, but must wait for rescue personnel. In the meantime, ventilation in the immediate area may be restricted and breathing may become difficult due to the accumulation of smoke and airborne contaminants. In order to survive, a person may need a rescue breather apparatus. Nevertheless, conventional breather apparatus are expensive, and may also be too heavy for children, the elderly, and the disabled to wear or carry. Consequently, there is a need for a rescue breather device that is relatively inexpensive, lightweight, and portable so that it becomes economical to maintain such an emergency respirator device in homes, offices, restaurants, and other environments where people may become at risk.

Thus, a portable respirator with oxygen supply solving the aforementioned problems is desired.

### SUMMARY OF THE INVENTION

The portable emergency respirator comprises a case having a compartment therein. Oxygen supply means is disposed inside of the heat resistant container body. An elongated tube connected to an airtight aperture of container body extends from the container body to deliver oxygen to an oxygen respirator mask. The oxygen respirator mask has a plurality of head straps and adjustment buckles. The respirator mask is preferably rubber sealed for efficient delivery of oxygen to the wearer and to prevent toxic environmental air from reaching the wearer's lungs.

These and other features of the present invention will become readily apparent upon further review of the following specification and drawings.

### BRIEF DESCRIPTION. OF THE DRAWINGS

FIG. 1 is a front view of the portable respirator with oxygen supply, according to the present invention.

FIG. 2 is a rear view of the portable respirator with oxygen supply, according to the present invention.

FIG. 3 is a perspective view of the battery pack with charger, according to the present invention.

FIG. 4 is a front view of the portable respirator with oxygen supply inside a convenient carrying pouch, according to the present invention.

Similar reference characters denote corresponding features consistently throughout the attached drawings.

### DETAILED DESCRIPTION OF THE PREFERRED EMBODIMENT

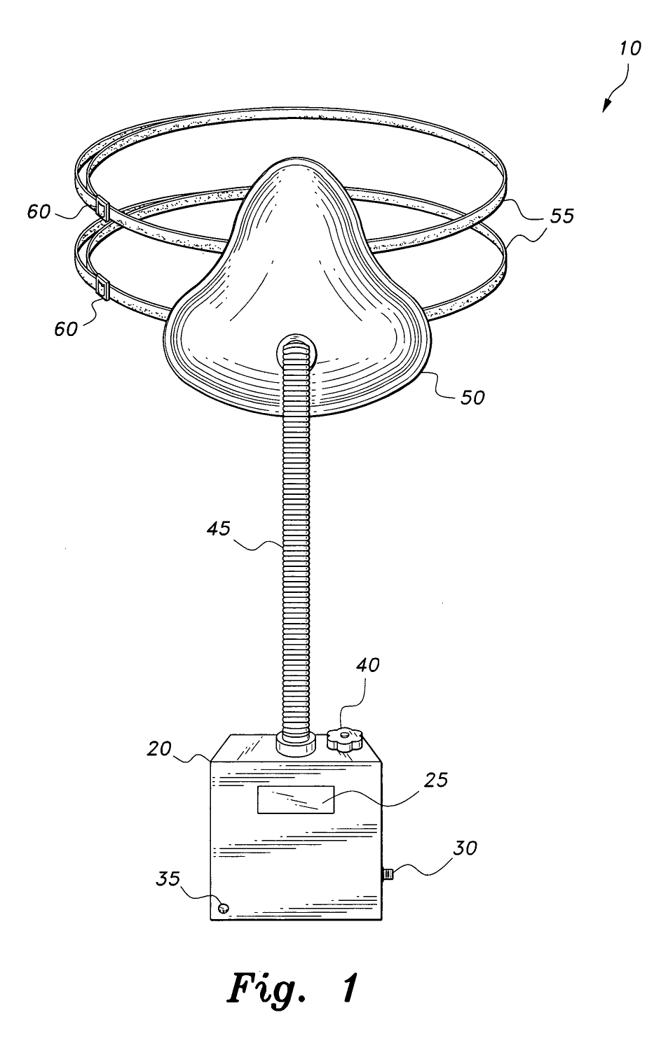

As shown in FIG. 1, the present invention, a portable emergency respirator 10 comprises a case 20 having a compartment therein. Oxygen supply means is disposed inside of the heat resistant container body 20. An elongated tube 45 connected to an airtight aperture of container body 20 extends from the container body 20 to deliver oxygen to an oxygen respirator mask 50. The oxygen respirator mask 50 has a plurality of head straps 55 and adjustment buckles 60.

The respirator mask 50 is preferably rubber sealed for efficient delivery of oxygen to the wearer and to prevent toxic environmental air from reaching the wearer's lungs. The container body with oxygen supply 20 preferably is about the size of a PDA or smart-phone.

The respirator preferably weights a maximum of approximately 3.5 pounds. Preferably the supply of oxygen can last approximately 35 to 40 minutes, and is refillable. An on/off valve 40 is disposed on the container 20 to activate/deactivate oxygen delivery by the system 10. The container has a built-in light 25 that emits a wavelength capable of penetrating smoke and haze so a user can see through the smoke.

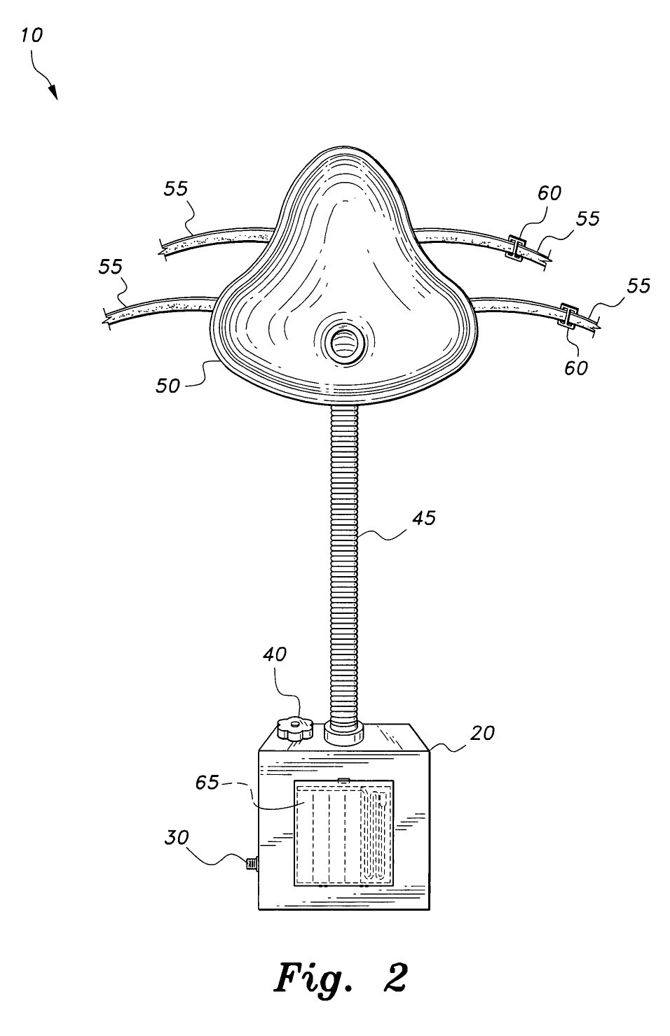

As shown in FIG. 2, power for the unit can be supplied by batteries in a rechargeable power pack 65 which is disposed on the rear of the case 20. A two colored light, preferably red and green may be disposed on the container 20. A red emission from the light indicates that the unit 10 requires charging. A green emission from the light indicates that the unit 10 is fully charged and ready to be used.

An alarm 35 is disposed on the container and may emit sounds and light to alert a fire fighter or other emergency personal of the wearer's whereabouts. Lighting on the unit 10 may also be used as a night light. When the valve 40 is turned on, the lights, such as light 25, on the system 10 are activated.

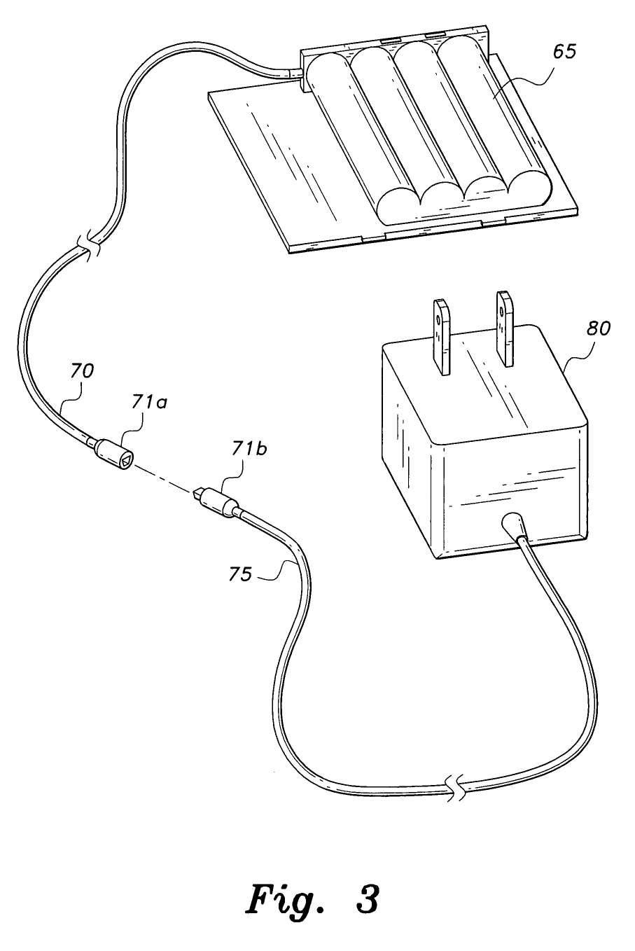

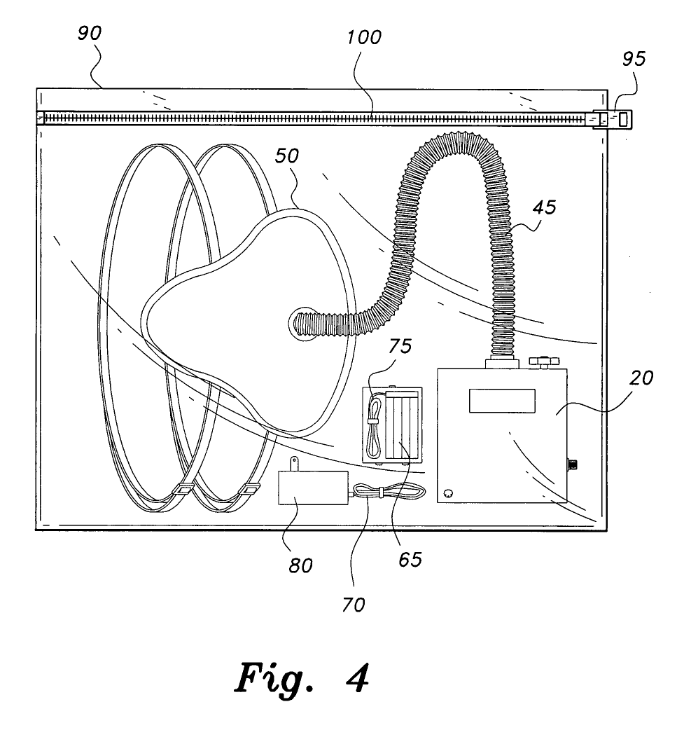

An oxygen supply means resupply nipple 30 is disposed on the case 20 for replenishing the unit 10 with useable oxygen supply. Lights such as light 25 and ultra-light/beeper 35 may be equipped with a strobe signal to alert EMS during emergencies. Green light strobe and red light strobe may have a different duty cycle to indicate different conditions such as safe versus life-threatening conditions. As shown in FIG. 3, a charger 80 is also supplied with quick connector 71b on the charger line 75 and quick connector 71a on the battery pack 65 line 70. As shown in FIG. 4, all components of the unit 10 can be stored in a reseal-able pouch 90. The pouch may have a seam 100 for slidable zipper 95.

It is to be understood that the present invention is not limited to the embodiment described above, but encompasses any and all embodiments within the scope of the following claims.

I claim:

1. A portable respirator with oxygen supply, comprising:
a fire resistant oxygen container body, the container body having:
a valve;
at least one light;
an ultralight indicator and sound;
oxygen supply means disposed inside of the container body; and
an oxygen supply means re-supply nipple;
a battery pack connectable to the container body;
a battery pack charger connectable to the battery pack;
a respirator mask; and
an air tube extending between the container body and the respirator mask for transport of oxygen from the container to the respirator mask; and
wherein the portable respirator supplies oxygen for a finite time for use by a user when the valve is turned to an on position.

2. The portable respirator with oxygen supply according to claim 1, wherein the oxygen supply means can supply up to approximately forty minutes of useable oxygen for the user.

3. The portable respirator with oxygen supply according to claim 1, wherein the valve is an on/off valve that activates and alternatively deactivates the oxygen supply to the user.

4. The portable respirator with oxygen supply according to claim 1, wherein the at least one light can emit at least one color and may have a first predetermined strobe rate for indication of an emergency condition and a second predetermined strobe rate for indication of a safe condition.

5. The portable respirator with oxygen supply according to claim 1, further comprising a flexible pouch adapted for conveniently carrying all components of the portable respirator with oxygen supply.
